(19) United States
(12) Patent Application Publication
(10) Pub. No.: US 2026/0034823 A1
(43) Pub. Date: Feb. 5, 2026

(54) DRYING DEVICE AND RECORDING DEVICE

(71) Applicant: SEIKO EPSON CORPORATION, Tokyo (JP)

(72) Inventor: Tadashi AIZAWA, MATSUMOTO-SHI (JP)

(21) Appl. No.: 19/284,468

(22) Filed: Jul. 29, 2025

(30) Foreign Application Priority Data
Jul. 30, 2024 (JP) 2024-123053

(51) Int. Cl. B41M 7/00

(52) U.S. Cl. CPC B41M 7/0081

(57) ABSTRACT

The drying device includes an electromagnetic wave generation section that dries a medium onto which a liquid is ejected by generating an electromagnetic wave in response to application of a high-frequency voltage. The electromagnetic wave generation section includes a first electrode, a second electrode disposed so as to surround at least a portion of the first electrode in plan view from a first direction, a first conductor including a coil and electrically coupling the first electrode and a transmission line, which is configured to transmit a high-frequency voltage, and a second conductor electrically coupling the transmission line and the second electrode. The first electrode is provided on a first surface side of the medium. The second electrode is provided at least on a second surface side of the medium opposite to the first surface.

The present application is based on, and claims priority from JP Application Serial Number 2024-123053, filed Jul. 30, 2024, the disclosure of which is hereby incorporated by reference herein in its entirety.

### BACKGROUND

### 1. Technical Field

The present disclosure relates to a drying device and a recording device.

### 2. Related Art

For example, as in JP-A-2021-8969, a drying device that dries a medium by generating electromagnetic waves on the medium onto which liquid has been ejected is disclosed. Such a drying device generates a strong electric field in the medium by supplying a high-frequency voltage between the first electrode and the second electrode.

By this, a medium onto which the liquid was ejected can be dried.

However, in such a drying device, it is desirable to improve the drying efficiency of the liquid ejected onto the medium by efficiently transmitting the electromagnetic wave to the liquid ejected onto the medium.

### SUMMARY

A drying device for solving the above problem includes an electromagnetic wave generation section that dries a medium onto which a liquid is ejected by generating an electromagnetic wave in response to application of a high-frequency voltage, wherein the electromagnetic wave generation section includes a first electrode, a second electrode disposed so as to surround at least a portion of the first electrode in plan view from a first direction, a first conductor including a coil and electrically coupling the first electrode and a transmission line, which is configured to transmit a high-frequency voltage, and a second conductor electrically coupling the transmission line and the second electrode, the first electrode is provided on a first surface side of a medium, and the second electrode is provided at least on a second surface side of the medium opposite to the first surface.

A recording device that solves the above-described problem includes a recording section that performs recording by ejecting liquid onto a medium and an electromagnetic wave generation section that dries the medium onto which the liquid has been ejected by the recording section by generating electromagnetic waves in accordance with application of a high-frequency voltage, wherein the electromagnetic wave generation section includes a first electrode, a second electrode disposed so as to surround at least a portion of the first electrode in plan view from a first direction, a first conductor including a coil and electrically coupling the first electrode and a transmission line, which is configured to transmit a high-frequency voltage, and a second conductor electrically coupling the transmission line and the second electrode, the first electrode is provided on a first surface side of a medium, and the second electrode is provided at least on a second surface side of the medium opposite to the first surface.

### BRIEF DESCRIPTION OF THE DRAWINGS

FIG. 1 is a schematic diagram showing a recording system of a first embodiment.

FIG. 2 is a perspective view showing a drying unit of the first embodiment.

FIG. 3 is a perspective view showing an electromagnetic wave generation section of the first embodiment.

FIG. 4 is a top view showing the electromagnetic wave generation section of the first embodiment.

FIG. 5 is a perspective view showing an electromagnetic wave generation section of a second embodiment.

### DESCRIPTION OF EMBODIMENTS

### First Embodiment

Hereinafter, an embodiment of a recording system including a drying device and a recording device will be described. In the following description, a direction intersecting a vertical direction Z is referred to as a width direction X, and a direction intersecting the vertical direction Z and the width direction X is referred to as a depth direction Y. One direction along the width direction X is referred to as a first width direction X1, and the other direction along the width direction X is referred to as a second width direction X2. One direction along the depth direction Y is referred to as a first depth direction Y1, and the other direction along the depth direction Y is referred to as a second depth direction Y2. An upward direction in the vertical direction Z is defined as an upward direction Z1, and a downward direction in the vertical direction Z is defined as a downward direction Z2. The vertical direction Z corresponds to an example of a first direction. The width direction X corresponds to an example of a second direction. A plan view from the vertical direction Z is simply referred to as a plan view.

### Configuration of Recording System 10

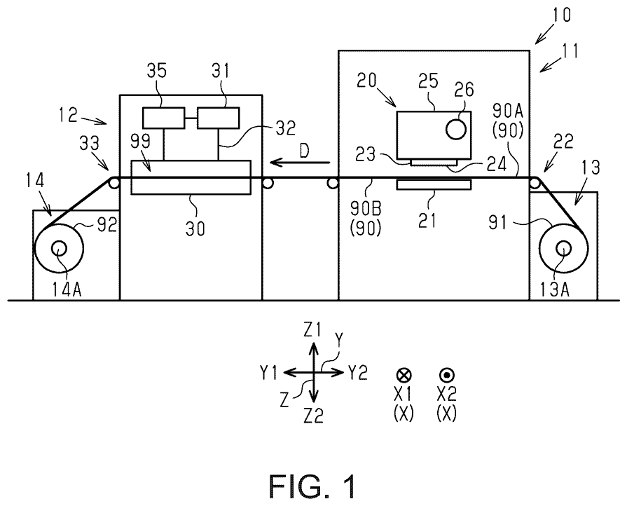

As shown in FIG. 1, a recording system 10 is a system that performs recording on a medium 90. In particular, the recording system 10 is a system that performs recording on the medium 90 by ejecting liquid onto the medium 90. The recording system 10 is a system that dries the medium 90 after recording onto which liquid was ejected.

The recording system 10 includes a recording device 11. The recording device 11 is configured to perform recording on the medium 90. In particular, the recording device 11 performs recording on the medium 90 by ejecting liquid onto the medium 90. The recording device 11 may be an inkjet type printer that performs recording by ejecting ink, which is an example of liquid, onto the medium 90. The medium 90 includes a front face 90A and a rear face 90B. The medium 90 is fabric, but may be, for example, paper.

The recording system 10 includes a drying device 12. The drying device 12 is configured to dry the medium 90 after recording onto which the recording device 11 ejected liquid. In particular, the drying device 12 generates an electromagnetic wave to dry the medium 90 after recording.

The recording system 10 includes a feeding section 13. The feeding section 13 feeds the medium 90 before recording to the recording device 11. The feeding section 13 includes a feed roller 13A. The feed roller 13A extends along the width direction X. In the width direction X, the width of the feed roller 13A is longer than the width of the medium 90. The feed roller 13A is configured to rotatably hold a first roll body 91. The first roll body 91 is the medium 90 before recording that is wound and stacked. The medium 90 may be elongated. In this way, the feed roller 13A holds the medium 90 to be fed to the recording device 11.

The recording system 10 includes a winding section 14. The winding section 14 winds up the medium 90 after recording by the recording device 11. In particular, the winding section 14 winds up the medium 90 after recording and drying by the drying device 12. The winding section 14 includes a winding roller 14A. The winding roller 14A extends along the width direction X. In the width direction X, the width of the winding roller 14A is longer than the width of the medium 90. The winding roller 14A is configured to rotatably hold a second roll body 92. The second roll body 92 is the medium 90 after recording that is wound and stacked. In this way, the winding roller 14A winds up the medium 90 that was recorded by the recording device 11 and dried by the drying device 12.

### Configuration of Recording Device 11

Here, the configuration of the recording device 11 will be described in detail.

The recording device 11 includes a recording section 20, a recording medium support section 21, and a recording medium transport section 22. The recording section 20 is configured to perform recording on the medium 90 by ejecting liquid onto the medium 90. The recording section 20 is configured to perform recording on the medium 90 by ejecting liquid onto the front face 90A of the medium 90. The recording section 20 performs recording on the medium 90 supported by the recording medium support section 21. The recording section 20 performs recording on the medium 90 transported by the recording medium transport section 22.

The recording section 20 includes a head 23. The head 23 may be a serial head or may be a line head. A serial head is one that scans in the width direction X of the medium 90. A line head is a head that records simultaneously across the width direction X of the medium 90.

The head 23 includes a nozzle surface 24 in which nozzles (not shown) are opened. The nozzle surface 24 is a surface facing the downward direction Z2. The nozzle surface 24 is a surface facing the front face 90A of the medium 90 transported by the recording medium transport section 22. Each of the plurality of nozzles is configured to open up in the downward direction Z2. Each of the plurality of nozzles is configured to eject liquid.

The recording section 20 may include a carriage 25 and a carriage support section 26. The carriage 25 is configured to support the head 23. The carriage support section 26 extends along the width direction X. The carriage support section 26 supports the carriage 25 so as to be movable along the width direction X. The carriage 25 is movable in the width direction X along the carriage support section 26 by a driving force from a driving source (not shown).

The recording medium support section 21 is configured to support the medium 90 transported by the recording medium transport section 22. The recording medium support section 21 is positioned in the downward direction Z2 of the recording section 20. The recording medium support section 21 supports the rear face 90B of the medium 90 transported by the recording medium transport section 22. The recording medium support section 21 is positioned in the downward direction Z2 of the head 23.

The recording medium transport section 22 is configured to transport the medium 90 in a transport direction D. The transport direction D is a direction along the depth direction Y. The recording medium transport section 22 may include a plurality of rollers. Although the recording transport section 22 transports the medium 90 in the transport direction D using the plurality of rollers, the recording medium transport section 22 may transport the medium 90 in the transport direction D using a transport belt driven by a plurality of rollers. The recording medium transport section 22 may perform intermittent transport in which the transport and stop of the medium 90 are repeated.

### Configuration of Drying Device 12

Next, the configuration of the drying device 12 will be described in detail.

The drying device 12 includes a drying unit 30. The drying unit 30 is configured to dry the medium 90 after recording. That is, the drying device 12 sets the medium 90 on which recording is performed by the recording section 20 as an target to be dried.

The drying unit 30 is configured to dry the medium 90 after recording by generation of electromagnetic waves. The drying unit 30 may be located so as to extend over the upward direction Z1 and the downward direction Z2 of the medium 90.

The drying device 12 includes a high-frequency voltage generation section 31. The high-frequency voltage generation section 31 is configured to generate a high-frequency voltage. The high-frequency voltage generation section 31 supplies a high-frequency voltage to the drying unit 30 through a transmission line 32. The high-frequency voltage generation section 31 is configured to supply a high-frequency voltage to at least one electromagnetic wave generation section 36 described later.

The high-frequency voltage generation section 31 may use an inverting full-bridge structure, but may be, for example, a class E amplifier circuit or a EF2 class inverting circuit. The high-frequency voltage generation section 31 may use a rectified commercial AC power supply.

The transmission line 32 is a line for being coupled the drying unit 30 with the high-frequency voltage generation section 31.

The transmission line 32 is capable of transmitting a high-frequency voltage from the high-frequency voltage generation section 31 to the drying unit 30. That is, the transmission line 32 is capable of transmitting a high-frequency voltage.

The transmission line 32 may be a coaxial cable, but is not limited to a coaxial cable. The transmission line 32 may include a first line and a second line. The first line may be a core line of the transmission line 32. The second line may be an electromagnetic shield that covers the first line.

The drying device 12 includes a drying transport section 33. The drying transport section 33 is configured to transport the medium 90 in the transport direction D. The transport direction D may be the first depth direction Y1. The drying transport section 33 is configured to transport the medium 90 along the transport path 99. The drying transport section 33 may transport the medium 90 in the transport direction D using a plurality of rollers. The drying transport section 33 may perform continuous transport in which the medium 90 is continuously transported. Slackening of the medium 90 may occur between the recording medium transport section 22 and the drying transport section 33.

The drying device 12 includes a control section 35. The control section 35 controls the drying device 12. Specifically, the control section 35 controls the drying unit 30. The control section 35 controls the high-frequency voltage generation section 31. The control section 35 controls the drying transport section 33.

The control section 35 may be constituted by one or more processors that execute various processes in accordance with a computer program. The control section 35 may be composed of one or more dedicated hardware circuits. The control section 35 may be configured with an application specific integrated circuit that executes at least a part of various processes. The control section 35 may be composed of a processor and a circuit including a combination of hardware circuits. The processor includes a CPU and memories such as a RAM and a ROM. The memory stores program codes or commands configured to cause the CPU to perform processes. Memory, that is computer-readable medium, includes any readable medium that can be accessed by a general-purpose or dedicated computer.

### Configuration of Drying Unit 30

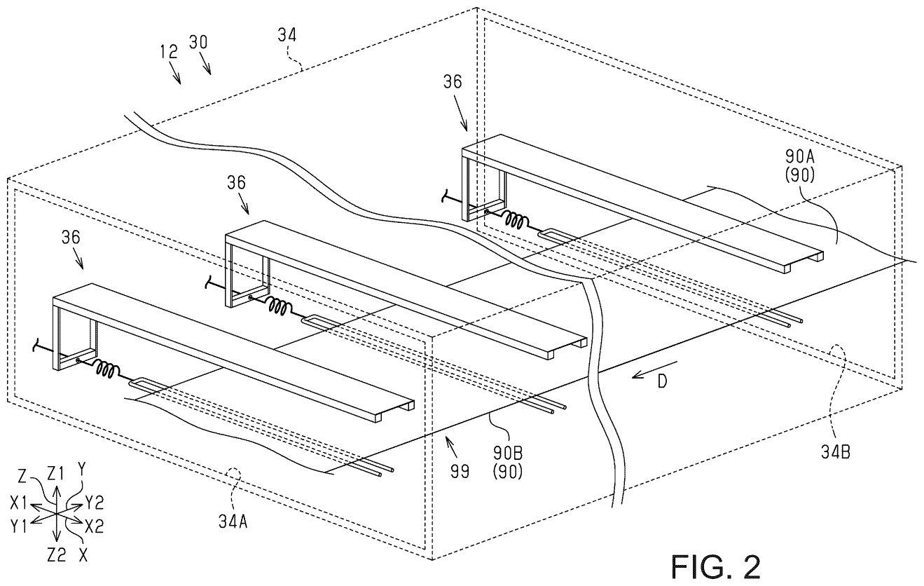

As shown in FIG. 2, the drying unit 30 includes a conductive housing 34 and an electromagnetic wave generation section 36. In other words, the drying device 12 includes the conductive housing 34 and the electromagnetic wave generation section 36. The drying unit 30 may include a conductive housing 34 and a plurality of electromagnetic wave generation section 36. In FIG. 2, the conductive housing 34 is indicated by a dashed line.

The conductive housing 34 may be provided inside the housing of the drying device 12. The conductive housing 34 has conductivity. The conductive housing 34 is configured to accommodate the electromagnetic wave generation section 36. The conductive housing 34 may be configured to accommodate a plurality of electromagnetic wave generation sections 36. The conductive housing 34 has a cylindrical shape along the transport path 99 of the medium 90. The conductive housing 34 may be provided such that the transport direction D is the longitudinal direction.

The conductive housing 34 includes an discharge port 34A. The discharge port 34A is provided in the first depth direction Y1 of the conductive housing 34. The discharge port 34A is provided to discharge the medium 90 from the inside to the outside of the conductive housing 34. The conductive housing 34 includes a receiving port 34B. The receiving port 34B is provided in the second depth direction Y2 of the conductive housing 34. The receiving port 34B is provided to transport the medium 90 from the outside to the inside of the conductive housing 34.

The plurality of electromagnetic wave generation section 36 are provided so as to be arranged along the transport direction D inside the conductive housing 34. The plurality of electromagnetic wave generation section 36 are arranged along the transport path 99. The electromagnetic wave generation section 36 may have a rectangular shape in a plan view from the vertical direction Z. The electromagnetic wave generation section 36 may be arranged such that the width direction X is the longitudinal direction.

The electromagnetic wave generation section 36 is configured to generate an electromagnetic wave in response to application of a high-frequency voltage. The electromagnetic wave generation section 36 generates an electromagnetic wave in response to the application of a high-frequency voltage. By this, the electromagnetic wave generation section 36 is configured to dry the medium 90 onto which the liquid is ejected by the recording section 20. The electromagnetic wave generation section 36 is a drying section.

The electromagnetic wave generation section 36 generates an alternating electric field by generating an electromagnetic wave. The electromagnetic wave generated by the electromagnetic wave generation section 36 has an electric field as a main component. The electromagnetic wave generation section 36 can extremely reduce induction of a magnetic field by a generated electric field, compared to a generating section that generates a normal electromagnetic wave.

As a specific example, the electromagnetic wave generation section 36 generates electromagnetic wave of 2.4 GHz, but the present disclosure is not limited thereto. The electromagnetic wave generation section 36 may generate electromagnetic waves of 3 MHz to 300 MHz, for example. The electromagnetic wave generation section 36 may generate, for example, electromagnetic waves of 300 MHz to 30 GHz, and among them, may generate electromagnetic waves of 10 MHz to 20 GHz.

### Configuration of Electromagnetic Wave Generation Section 36

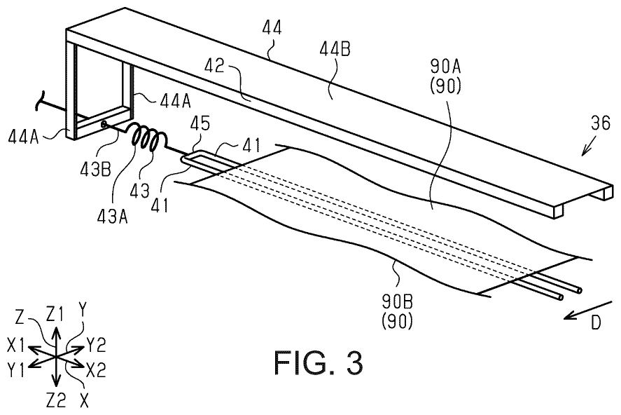

As shown in FIG. 3, the electromagnetic wave generation section 36 includes a first electrode 41, a second electrode 42, a first conductor 43, and a second conductor 44. That is, the drying device 12 includes the first electrode 41, the second electrode 42, the first conductor 43, and the second conductor 44.

The first electrode 41 has a rod shape, but may have a flat plate shape. The first electrode 41 is elongated in the width direction X in plan view. That is, the first electrode 41 extends in the width direction X in plan view. The first electrode 41 may have a rectangular shape in plan view. The first electrode 41 is located at the downward direction Z2 of the medium 90. That is, the first electrode 41 is provided on the rear face 90B side of the medium 90. The rear face 90B corresponds to an example of a first surface.

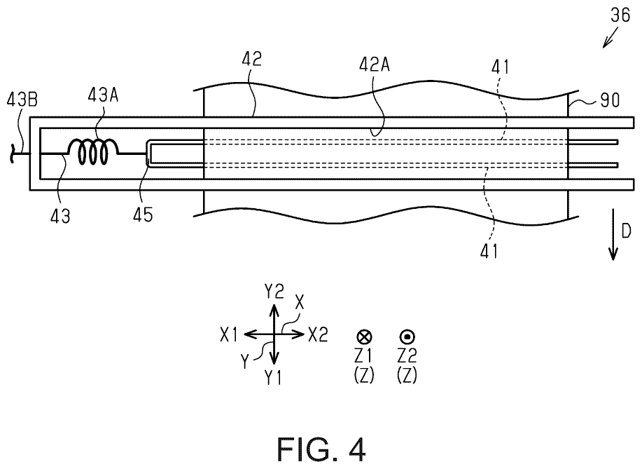

As shown in FIG. 4, the electromagnetic wave generation section 36 may include a plurality of first electrodes 41. The electromagnetic wave generation section 36 includes two first electrodes 41, but may include one or three or more first electrodes 41. The plurality of first electrodes 41 are arranged side by side in the depth direction Y. FIG. 4 is a view in which the second conductor 44 is omitted.

The electromagnetic wave generation section 36 may include a connection section 45. The connection section 45 is configured to connect the plurality of first electrodes 41. The connection section 45 is made of metal. The connection section 45 is configured to be electrically coupled the plurality of first electrodes 41. The connection section 45 is coupled to the first conductor 43.

By this, the connection section 45 is configured to be electrically coupled the plurality of first electrodes 41 and the first conductor 43. The connection section 45 may be included in the first conductor 43. The connection section 45 may be included in any of the first electrodes 41.

As shown in FIG. 3, the second electrode 42 has a flat plate shape. The second electrode 42 is elongated in the width direction X in plan view. That is, the second electrode 42 extends in the width direction X in plan view. The second electrodes 42 are located in the upward direction Z1 of the first electrodes 41. The second electrodes 42 are located at the upward direction Z1 of the medium 90. That is, the second electrodes 42 are provided at least on the front face 90A of the medium 90. The front face 90A corresponds to an example of a second face.

As shown in FIG. 4, the second electrode 42 include a cutout section 42A. The cutout section 42A is configured to surround at least a part of the first electrode 41 in plan view. The cutout section 42A may be provided so as to surround the first depth direction Y1 side, the second depth direction Y2 side, and the first width direction X1 side of the first electrodes 41 in plan view. The cutout section 42A may be provided so as not to surround the second width direction X2 side of the first electrode 41 in plan view.

In this manner, the second electrode 42 is arranged so as to surround at least a portion of the first electrode 41 in plan view. The second electrode 42 may be arranged so as to surround at least a portion of the plurality of first electrodes 41 in plan view.

As shown in FIG. 3, the first conductor 43 is configured to be electrically coupled with the transmission line 32 and the first electrode 41. The first conductor 43 includes a coil 43A. The coil 43A may extend in the vertical direction Z. One end of the coil 43A is coupled with the first electrode 41. The other end of the coil 43A is coupled with a lead wire 43B. The lead wire 43B is coupled with the transmission line 32. As shown in FIG. 4, the second electrodes 42 may be arranged so as to surround at least a portion of the coil 43A in plan view.

As shown in FIG. 3, the second conductor 44 is configured to be electrically coupled the transmission line 32 with the second electrode 42. The second conductor 44 may include a pillar 44A. The second conductor 44 may include a plurality of pillar 44A. The pillar 44A are electrically coupled with the second electrode 42. The pillar 44A extends from the second electrodes 42 toward the downward direction Z2. The pillar 44A is made of metal. The pillar 44A is provided on the first width direction X1. The pillar 44A may not be provided on the second width direction X2. In this way, the second conductor 44 is configured to support the second electrode 42 on either one side in the width direction X.

The second conductor 44 may include a top board 44B. The top board 44B is electrically coupled with the second electrodes 42. The top board 44B is provided on the upward direction Z1 of the second electrode 42. The top board 44B connects a plurality of the pillar 44A. The top board 44B is made of metal. The top board 44B is located on the upward direction Z1 side of the medium 90. In this manner, the second conductor 44 is provided at least on the front face 90A side of the medium 90.

With the electromagnetic wave generation section 36 configured as described above, when a high-frequency voltage is applied, the first electrode 41 and the second electrode 42 generate electromagnetic waves in accordance with the application of the high-frequency voltage, thereby heating the medium 90.

The electromagnetic wave generation section 36 may transfer a large amount of thermal energy to the medium 90 by generating the electromagnetic wave. The electromagnetic wave generation section 36 is not a heat conduction type but an electromagnetic wave type, and may not include components such as a heating wire for heating. By this, this makes it possible to reduce the size of the electromagnetic wave generation section 36.

The minimum separation distance between the first electrode 41 and the second electrode 42 is equal to or less than one-tenth of the wavelength of the electromagnetic wave output from the electromagnetic wave generation section 36. The minimum separation distance between the first conductor 43 and the second conductor 44 may be equal to or less than one-tenth of the wavelength of the electromagnetic wave output from the electromagnetic wave generation section 36. By this, electromagnetic waves generated when a high frequency voltage is applied can be attenuated in the vicinity of the first electrode 41 and the second electrode 42. By this, it is possible to reduce the intensity of an electromagnetic wave that reaches a distant place from the first electrode 41 and the second electrode 42. That is, the electromagnetic wave generated from the electromagnetic wave generation section 36 is very strong in the vicinity of the first electrode 41 and the second electrode 42, and is very weak in the distance.

The electromagnetic wave generation section 36 can intensively generate an alternating electric field in the vicinity of the first electrode 41 and the second electrode 42 by appropriately controlling the frequency band of the electromagnetic wave to be generated. In other words, it is possible to suppress the influence on the surroundings accompanying the generation of electromagnetic waves beyond the vicinity of the first electrode 41 and the second electrode 42. The vicinity of the first electrode 41 and the second electrode 42 may correspond to a range of, for example, 3 mm to 3 cm.

### Operation and Effects of the First Embodiment

The operation and effects of the first embodiment will be described.

1: The first electrodes 41 are provided on the rear face 90B side of the medium 90, and the second electrodes 42 are provided at least on the front face 90A side of the medium 90. According to this configuration, the electromagnetic wave generated between the first electrode 41 and the second electrode 42 can be efficiently transmitted to the liquid ejected onto the medium 90, compared to a case where the first electrode 41 and the second electrode 42 are provided on the same side of the medium 90 in the vertical direction Z. Therefore, it is possible to improve the drying efficiency of the liquid ejected onto the medium 90.

In particular, the first electrode 41 and the second electrode 42 are in a state of sandwiching the medium 90, and the second electrode 42 is configured to cover at least a part of the first electrode 41 in a plan view, and thus, for example, concentration of an electric field such as corona discharge or the like can be suppressed. In addition, the electromagnetic waves can be equalized, and the heating region for the liquid ejected onto the medium 90 can be expanded.

2: The second conductor 44 are provided at least on the front face 90A side of the medium 90. According to this configuration, by providing at least the second conductor 44 electrically coupled to the second electrodes 42 on the front face 90A side of the medium 90, it is possible to improve the drying effect of the liquid ejected onto the medium 90.

3: The first electrode 41 extends in the width direction X, and the second conductor 44 is configured to support the second electrode 42 on one side in the width direction X. According to this configuration, the second conductor 44 can be configured to support the second electrode 42 with a simple configuration.

4: The conductive housing 34 is configured to accommodate the electromagnetic wave generation section 36. According to this configuration, the electromagnetic wave generation section 36 itself is accommodated in the conductive housing 34, and thus the electromagnetic wave generated from the electromagnetic wave generation section 36 can be stably supplied to the liquid ejected onto the medium 90. Therefore, it is possible to improve the drying efficiency of the liquid ejected onto the medium 90.

5: The conductive housing 34 is configured to accommodate the plurality of electromagnetic wave generation section 36. According to this configuration, the electromagnetic wave can be efficiently transmitted to the liquid ejected onto the medium 90 over a wide range. Therefore, it is possible to improve the drying efficiency of the liquid ejected onto the medium 90.

6: The electromagnetic wave generation section 36 includes the plurality of first electrodes 41. The second electrode 42 is arranged so as to surround at least a portion of the plurality of first electrodes 41 in plan view. According to this configuration, the electromagnetic wave generated between the first electrode 41 and the second electrode 42 can be efficiently transmitted to the liquid ejected onto the medium 90, compared to a case where the first electrode 41 and the second electrode 42 are provided on the same side of the medium 90 in the vertical direction Z. In particular, the electric field with respect to the liquid ejected onto the medium 90 can be equalized. Therefore, it is possible to improve the drying efficiency of the liquid ejected onto the medium 90.

7: The high-frequency voltage generation section 31 is configured to supply a high-frequency voltage to at least one electromagnetic wave generation section 36. According to this configuration, it is possible to stably supply a high-frequency voltage to the electromagnetic wave generation section 36. Therefore, it is possible to improve the drying efficiency of the liquid ejected onto the medium 90.

8: The minimum separation distance between the first electrode 41 and the second electrode 42 is equal to or less than one-tenth of the wavelength of the electromagnetic wave output from the electromagnetic wave generation section 36. According to this configuration, the generated electromagnetic waves can be attenuated in the vicinity of the first electrode 41 and the second electrode 42. By this, it is possible to reduce the intensity of an electromagnetic wave that reaches a distant place from the first electrode 41 and the second electrode 42. Therefore, the electromagnetic wave generated from the electromagnetic wave generation section 36 is very strong in the vicinity of the first electrode 41 and the second electrode 42, and is very weak in the distance.

9: The minimum separation distance between the first conductor 43 and the second conductor 44 is equal to or less than one-tenth of the wavelength of the electromagnetic wave output from the electromagnetic wave generation section 36. According to this configuration, the generated electromagnetic waves can be attenuated in the vicinity of the first electrode 41 and the second electrode 42. By this, it is possible to reduce the intensity of an electromagnetic wave that reaches a distant place from the first electrode 41 and the second electrode 42. Therefore, the electromagnetic wave generated from the electromagnetic wave generation section 36 is very strong in the vicinity of the first electrode 41 and the second electrode 42, and is very weak in the distance.

### Second Embodiment

Next, a second embodiment will be described. In the following description, redundant descriptions of configurations identical to those of the previously described embodiment will be omitted or simplified, and configurations that differ from the previously described embodiment will be detailed.

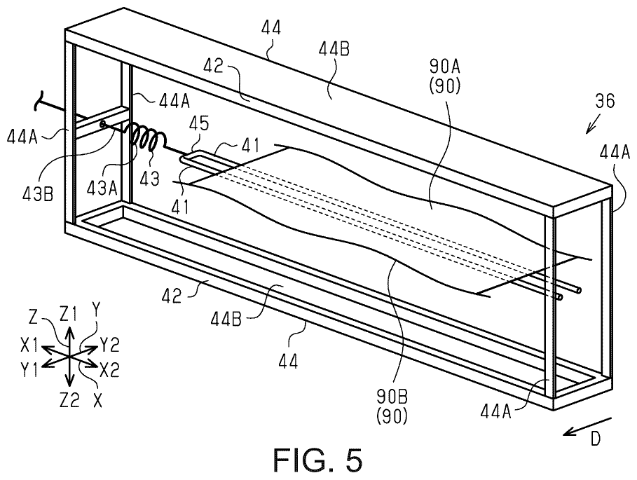

As shown in FIG. 5, in the second embodiment, the second electrodes 42 may be provided on both the upward direction Z1 side and the downward direction Z2 side of the first electrodes 41. The second conductors 44 may include pillars 44A on both the first width direction X1 side and the second width direction X2 side.

The pillar 44A is electrically coupled with both the second electrodes 42 on the upward direction Z1 and the second electrodes 42 on the downward direction Z2. The pillar 44A may be configured as the second electrode 42. In such a case, the second electrodes 42 and the pillar 44A are provided so as to cover the periphery of the first electrodes 41 when viewed from the width direction X.

### Modifications

The present embodiment can be implemented with the following modifications. The present embodiment and the following modifications can be implemented in combination with each other as long as there is no technical contradiction.
The electromagnetic wave generation section 36 may include an abutting section between the first electrode 41 and the medium 90. The abutting section is located on the rear face 90B side of the medium 90. The abutting section is arranged so as to face the rear face 90B of the medium 90. The abutting section may be configured not to abut the medium 90 or may be configured to abut the medium 90. The abutting section may have a flat plate shape. The abutting section is made of a material that transmits the electromagnetic wave generated by the electromagnetic wave generation section 36. The abutting section protects the first electrode. The abutting section is formed of an insulating component. The abutting section may be a glass plate. The abutting section may be a ceramic with a high transmittance. The abutting section may be made of a resin having a dielectric loss tangent. The abutting section may be made of polypropylene. The abutting section may be made of polyethylene.
The electromagnetic wave generation section 36 may include an abutting section between the second electrode 42 and the medium 90. The abutting section is arranged on the front face 90A side of the medium 90. The abutting section is arranged so as to face the front face 90A of the medium 90. The electromagnetic wave generation section 36 may include a first abutting section between the first electrode 41 and the medium 90, and a second abutting section between the second electrode 42 and the medium 90. The drying unit 30 may include an abutting section along the transport path 99.
The drying unit 30 may include a transport belt. The transport belt is configured to transport the medium 90 in a state of supporting the medium 90. The transport belt may be endless.

The transport belt may be arranged between the first electrode 41 and the medium 90. The transport belt may be the abutting section.
The second electrode 42 may be supported by multiple pillars 44A on both the first width direction X1 side and the second width direction X2 side. That is, the second electrodes 42 may be supported by the second conductor 44 on both the first width direction X1 side in the first width direction and the second width direction X2 side in the second width direction.
The second electrode 42 may be electrically coupled with the conductive housing 34. The second electrode 42 may be provided integrally with the conductive housing 34. The second conductor 44 may be electrically coupled to the conductive housing 34. The second conductor 44 may be provided integrally with the conductive housing 34. In such a case, both the second electrode 42 and the conductive housing 34 may be grounded.
The second electrode 42 may be configured to cover the second width direction X2 side of the first electrodes 41 in plan view and not to cover the first width direction X1 side of the first electrode 41 in plan view. The second electrodes 42 may be configured to cover the first width direction X1 side and the second width direction X2 side of the first electrodes 41 in plan view. In this case, the cutout section 42A may be an opening section. In this manner, the second electrode 42 may cover at least a portion of the first electrode 41 in plan view. In particular, as long as the conductive housing 34 is electrically coupled with the second electrode 42, the second electrode 42 may cover at least a part of the first electrode 41 in plan view.
The high-frequency voltage generation section 31 may be configured to supply high-frequency voltage to one electromagnetic wave generation section 36, or it may be configured to supply high-frequency voltage to multiple electromagnetic wave generation sections 36.
The electromagnetic wave generation section 36 may be arranged such that the depth direction Y is the longitudinal direction. The electromagnetic wave generation section 36 may be arranged so as to be inclined with respect to the width direction X and the depth direction Y. The plurality of electromagnetic wave generation sections 36 may be arranged in a plurality of rows in the width direction X. The plurality of electromagnetic wave generation section 36 may be arranged in a line in the depth direction Y.
The electromagnetic wave generation section 36 may be configured such that the first electrodes 41 are provided on the front face 90A of the medium 90 and the second electrodes 42 are provided at least on the rear face 90B of the medium 90. The electromagnetic wave generation section 36 may be capable of scanning in the width direction X.
The first electrode 41 is not limited to a rod shape, and may have, for example, a flat plate shape or a substantially flat plate shape. The substantially flat shape may include, for example, a shape curved in the thickness direction, which is a direction along the vertical direction Z, or a linear shape with an extremely large aspect ratio of a rectangular shape.
The second electrode 42 is not limited to a flat plate shape and may, for example, have a substantially flat plate shape. The substantially flat shape may include, for example, a shape curved in the thickness direction, which is a direction along the vertical direction Z, or a linear shape with an extremely large aspect ratio of a rectangular shape.
The electromagnetic wave generation section 36 may be provided in the recording device 11 instead of the drying device 12. That is, the recording device 11 may include the electromagnetic wave generation section 36. In this case, the electromagnetic wave generation section 36 may be provided on the downstream side of the recording section 20 in the transport direction D. In this manner, the electromagnetic wave generation section 36 may be applied to the recording device 11 instead of the drying device 12.
A lateral type printer may be adopted as the recording device 11. The lateral type printer is a printer in which the carriage 25 can move in two directions, a main scanning direction and a sub-scanning direction.

The medium 90 is not limited to a roll body. The medium 90 may be a paper sheet, a resin film or sheet, a resin-metal composite film, a laminate film, a textile, a nonwoven fabric, a metal foil, a metal film, a ceramic sheet, a garment, or the like.
The liquid can be arbitrarily selected as long as it can record on the medium 90 by being deposited on the medium 90. For example, ink includes ink in which particles of a functional material made of a solid material such as pigment or a metal particle are dissolved, dispersed, or mixed in a solvent, and includes various compositions such as water-based ink, oil-based ink, gel ink, and hot melt ink.
As used herein, the phrase “at least any” means one or more of the desired options. As an example, the phrase “at least any of” as used herein means only one option if the number of options is two, or both of the two options. As another example, the phrase “at least any” as used herein means only one option or a combination of any two or more options if the number of options is three or more.

### Supplementary Notes

Hereinafter, technical ideas grasped from the above-described embodiment and modifications, and operations and effects thereof will be described. The present technical idea and the operational effects thereof can be combined with each other within a technically consistent range.

[1] A drying device includes an electromagnetic wave generation section that dries a medium onto which a liquid is ejected by generating an electromagnetic wave in response to application of a high-frequency voltage, wherein the electromagnetic wave generation section includes a first electrode, a second electrode disposed so as to surround at least a portion of the first electrode in plan view from a first direction, a first conductor including a coil and electrically coupling the first electrode and a transmission line, which is configured to transmit a high-frequency voltage, and a second conductor electrically coupling the transmission line and the second electrode, and the first electrode is provided on a first surface side of a medium, and the second electrode is provided at least on a second surface side of the medium opposite to the first surface.

According to this configuration, compared to the case where the first electrode and the second electrode are arranged on the same side in the first direction of the medium, the electromagnetic waves generated between the first electrode and the second electrode can be efficiently transmitted to the liquid ejected onto the medium. Therefore, it is possible to improve the drying efficiency of the liquid ejected onto the medium.

[2] In the above-described drying device, the second conductor may be provided at least on the second surface side of the medium.

According to this configuration, by providing at least the second conductor electrically coupled with the second electrode on the second surface side of the medium, it is possible to improve the drying efficiency of the liquid ejected onto the medium.

[3] In the above-described drying device, the first electrode may extend in a second direction intersecting the first direction, and the second conductor may be configured to support the second electrode on one side in the second direction.

According to this configuration, the second conductor can be configured to support the second electrode with a simple configuration.

[4] The above-described drying device may include a conductive housing configured to accommodate the electromagnetic wave generation section.

According to this configuration, electromagnetic wave generation section itself is accommodated in the conductive housing, and thus it is possible to stably supply the electromagnetic wave generated from the electromagnetic wave generation section to the liquid ejected onto the medium. Therefore, it is possible to improve the drying efficiency of the liquid ejected onto the medium.

[5] The above-described drying device may include a conductive housing configured to accommodate a plurality of the electromagnetic wave generation sections.

According to this configuration, the electromagnetic wave can be efficiently transmitted to the liquid ejected onto the medium over a wide range. Therefore, it is possible to improve the drying efficiency of the liquid ejected onto the medium.

[6] In the above-described drying device, the electromagnetic wave generation section may include a plurality of the first electrodes, and the second electrode may be disposed to surround at least a part of the plurality of first electrodes in a plan view from the first direction.

According to this configuration, compared to the case where the first electrode and the second electrode are arranged on the same side in the first direction of the medium, the electromagnetic waves generated between the first electrode and the second electrode can be efficiently transmitted to the liquid ejected onto the medium. In particular, it is possible to achieve the equalization of the electric field with respect to the liquid ejected onto the medium. Therefore, it is possible to improve the drying efficiency of the liquid ejected onto the medium.

[7] The above-described drying device may include a high-frequency voltage generation section that generates a high-frequency voltage, and the high-frequency voltage generation section may be configured to supply a high-frequency voltage to at least one of the electromagnetic wave generation sections.

According to this configuration, it is possible to stably supply the high frequency voltage to the electromagnetic wave generation section. Therefore, it is possible to improve the drying efficiency of the liquid ejected onto the medium.

[8] In the above-described drying device, a minimum separation distance between the first electrode and the second electrode may be equal to or less than one-tenth of a wavelength of the electromagnetic wave output from the electromagnetic wave generation section.

According to this configuration, the generated electromagnetic wave can be attenuated in the vicinity of the first electrode and the second electrode. By this, the intensity of the electromagnetic waves reaching a distance from the first electrode and the second electrode can be reduced. Therefore, the electromagnetic wave generated from the electromagnetic wave generation section is very strong in the vicinity of the first electrode and the second electrode, and is very weak in the distance.

[9] In the above-described drying device, a minimum separation distance between the first conductor and the second conductor may be equal to or less than one-tenth of a wavelength of the electromagnetic wave output from the electromagnetic wave generation section.

According to this configuration, the generated electromagnetic wave can be attenuated in the vicinity of the first electrode and the second electrode. By this, the intensity of the electromagnetic waves reaching a distance from the first electrode and the second electrode can be reduced. Therefore, the electromagnetic wave generated from the electromagnetic wave generation section is very strong in the vicinity of the first electrode and the second electrode, and is very weak in the distance.

[10] A recording device includes a recording section that performs recording by ejecting liquid onto a medium and an electromagnetic wave generation section that dries the medium onto which the liquid has been ejected by the recording section by generating electromagnetic waves in accordance with application of a high-frequency voltage, wherein the electromagnetic wave generation section includes a first electrode, a second electrode disposed so as to surround at least a portion of the first electrode in plan view from a first direction, a first conductor including a coil and electrically coupling the first electrode and a transmission line, which is configured to transmit a high-frequency voltage, and a second conductor electrically coupling the transmission line and the second electrode, and the first electrode is provided on a first surface side of a medium, and the second electrode is provided at least on a second surface side of the medium opposite to the first surface. According to this configuration, the same effect as that of [1] can be achieved.

What is claimed is:

1. A drying device comprising:
an electromagnetic wave generation section that dries a medium onto which a liquid is ejected by generating an electromagnetic wave in response to application of a high-frequency voltage, wherein
the electromagnetic wave generation section includes
a first electrode,
a second electrode disposed so as to surround at least a portion of the first electrode in plan view from a first direction,
a first conductor including a coil and electrically coupling the first electrode and a transmission line, which is configured to transmit a high-frequency voltage, and
a second conductor electrically coupling the transmission line and the second electrode,
the first electrode is provided on a first surface side of a medium, and
the second electrode is provided at least on a second surface side of the medium opposite to the first surface.

2. The drying device according to claim 1, wherein
the second conductor is provided at least on the second surface side of the medium.

3. The drying device according to claim 1, wherein
the first electrode extends in a second direction intersecting the first direction and
the second conductor is configured to support the second electrode in one of the second directions.

4. The drying device according to claim 1, further comprising:
a conductive housing configured to accommodate the electromagnetic wave generation section.

5. The drying device according to claim 1, further comprising:
a conductor housing configured to accommodate a plurality of electromagnetic wave generation sections.

6. The drying device according to claim 1, wherein
the electromagnetic wave generation section includes a plurality of the first electrodes and
the second electrode is arranged so as to surround at least a part of the plurality of first electrodes in a plan view from the first direction.

7. The drying device according to claim 1, further comprising:
a high-frequency voltage generation section that generates a high-frequency voltage, wherein
the high-frequency voltage generation section is configured to supply a high-frequency voltage to at least one of the electromagnetic wave generation sections.

8. The drying device according to claim 1, wherein
a minimum separation distance between the first electrode and the second electrode is equal to or less than one-tenth of a wavelength of the electromagnetic wave output from the electromagnetic wave generation section.

9. The drying device according to claim 1, wherein
a minimum separation distance between the first conductor and the second conductor is equal to or less than one-tenth of a wavelength of the electromagnetic wave output from the electromagnetic wave generation section.

10. A recording device comprising:
a recording section that performs recording by ejecting liquid onto a medium and
an electromagnetic wave generation section that dries the medium onto which the liquid has been ejected by the recording section by generating electromagnetic waves in accordance with application of a high-frequency voltage, wherein
the electromagnetic wave generation section includes
a first electrode,
a second electrode disposed so as to surround at least a portion of the first electrode in plan view from a first direction,
a first conductor including a coil and electrically coupling the first electrode and a transmission line, which is configured to transmit a high-frequency voltage, and
a second conductor electrically coupling the transmission line and the second electrode, and
the first electrode is provided on a first surface side of a medium, and
the second electrode is provided at least on a second surface side of the medium opposite to the first surface.
